(19) United States
(12) Patent Application Publication
(10) Pub. No.: US 2014/0258283 A1
(43) Pub. Date: Sep. 11, 2014

(54) COMPUTING DEVICE AND FILE SEARCHING METHOD USING THE COMPUTING DEVICE

(71) Applicants: HON HAI PRECISION INDUSTRY CO., LTD., New Taipei (TW); GDS Software (ShenZhen) Co.,Ltd, Shenzhen (CN)

(72) Inventors: JEN-HSIUNG CHARNG, New Taipei (TW); CHI-LING LIN, New Taipei (TW); CHIEN-WEI LEE, New Taipei (TW); I-CHEN LEE, New Taipei (TW); ZHENG-MIN OU, Shenzhen (CN)

(73) Assignees: HON HAI PRECISION INDUSTRY CO., LTD., New Taipei (TW); GDS SOFTWARE (SHENZHEN) CO.,LTD, Shenzhen (CN)

(21) Appl. No.: 14/191,502

(22) Filed: Feb. 27, 2014

(30) Foreign Application Priority Data
Mar. 11, 2013 (CN) 2013100761474

(51) Int. Cl. G06F 17/30

(52) U.S. Cl. CPC G06F 17/30554
USPC 707/728

(57) ABSTRACT

In a file searching method using a computing device, the computing device connects to one or more terminal devices. An electronic file is obtained from a database when a file name is inputted from one of the terminal devices, and the file is analyzed to obtain a title and text content of the file. One or more keywords are extracted from each of the text content of the file using a term frequency-inverse document frequency (TF-IDF) rule. One or more interested terms are obtained from the keywords according to an importance factor of each of the keywords. The method obtains search results from the database according to the interested terms, and ranks the files according to a relevance degree between each file in the search results and the interested terms. The computing device sends the files with a ranking order to the terminal device.

### BACKGROUND

1. Technical Field

Embodiments of the present disclosure relate to information searching systems and methods, and particularly to a computing device and a file searching method using the computing device.

2. Description of Related Art

In current search technologies, some useful information may be missed and overlooked, while on the other hand, if a search query expression is too broad, some useful information may be buried deep inside search results and obscured by more useless information. Furthermore, rankings of the search results are based on the perceived “importance” of the search results through analysis of the hyper-linked relationships between the search results. With this technology, the ranking rules are predefined by searching systems and user-specified interests have no impact on the ranking of the searching results. In other words, the query by the user is not being customized, and a more efficient method for performing file search is therefore desirable.

### BRIEF DESCRIPTION OF THE DRAWINGS

FIG. 1 is a block diagram of one embodiment of a computing device comprising a file searching system.

FIG. 2 is a block diagram of one embodiment of the file searching system in the computing device.

FIG. 3 is a flowchart of one embodiment of a file searching method using the computing device.

FIG. 4 is a chart of one embodiment of files stored in a storage device of the computing device.

FIG. 5 is a chart of one embodiment of keywords recorded in a database of the storage device.

FIG. 6 is a chart of one embodiment of interested terms recorded in the database of the storage device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

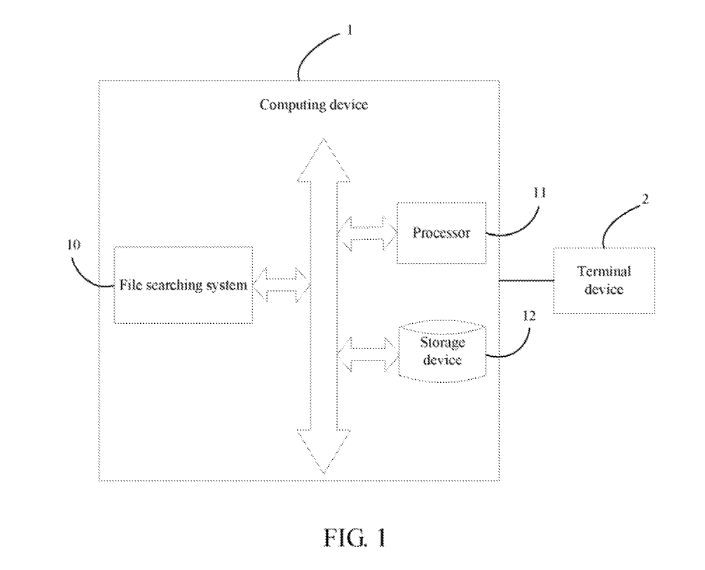

FIG. 1 is a block diagram of one embodiment of a computing device 1 comprising a file searching system 10. In the embodiment, the computing device 1 further comprises, but is not limited to, at least one processor 11 and a storage device 12. The file searching system 10 comprises computerized instructions in the form of one or more computer-readable programs, which are implemented by the at least one processor 11 of the computing device 1. In one embodiment, the computing device 1 can be a personal computer, a server computer, a workstation computer, or other suitable data processing device. FIG. 1 is only one example of the computing device 1, and other examples may comprise more or fewer components than those shown in the embodiment, or have a different configuration of the various components.

In the embodiment, the computing device 1 connects to one or more terminal devices 2 through a network, which can be a local area network (LAN) or a wide area network (WAN), such as an intranet or the Internet. The terminal device 2 may be a personal computer, a tablet device, a mobile phone or a personal digital assistant (PDA) device.

The at least one processor 11 can be a central processing unit (CPU), a microprocessor, or other suitable data processor chip that performs various functions of the computing device 1. In one embodiment, the storage device 12 can be an internal storage system, such as a flash memory, a random access memory (RAM) for temporary storage of information, and/or a read-only memory (ROM) for permanent storage of information. The storage device 12 can also be an external storage system, such as an external hard disk, a storage card, or a data storage medium.

In the embodiment, the storage device 12 stores a plurality of electronic files and a database that includes a keyword library, and a common term library. The electronic files stores various information to be the queried by a user of the terminal device 2. Each of the electronic files may be a webpage file, a document file, or a text file. The keyword library stores a plurality of keywords that are used frequently, and the keywords are also called “core terms.” For example, the keywords related “traffic” may include “highway,” “railway,” “subway,” “airplane,” “water transport” and etc. The common term library stores a plurality of common terms which are unimportant or unrelated to the keywords. For example, the common terms may include a plurality of periodic terms “today,” “yesterday,” “tomorrow,” and etc, a plurality of adjective terms “much,” “more,” “very,” and etc, and a plurality of pronoun term “we,” “they,” “he,” “she” and etc., for example.

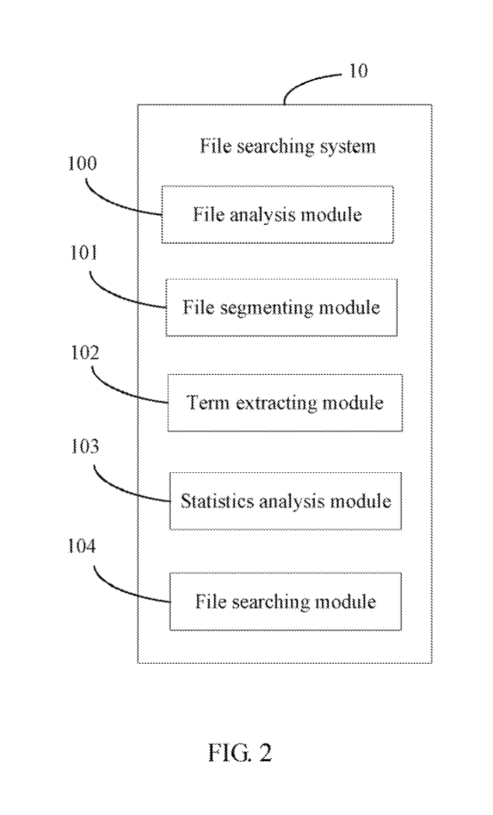

FIG. 2 is a block diagram of one embodiment of the file searching system 10 in the computing device 1. In the embodiment, the file searching system 10 comprises, but is not limited to, a file analysis module 100, a file segmenting module 101, a term extracting module 102, a statistics analysis module 103, and a file searching module 104. The modules 100-104 may comprise computerized instructions in the form of one or more computer-readable programs that are stored in a non-transitory computer-readable medium (such as the storage device 12) and executed by the at least one processor 11 of the computing device 1. A description of each module is given in the following paragraphs.

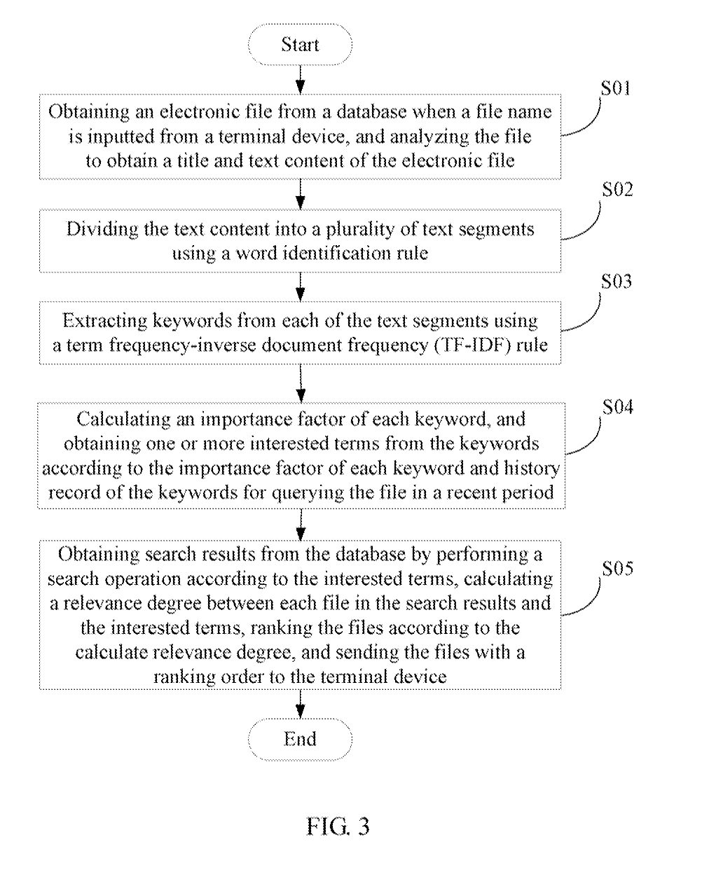

FIG. 3 is a flowchart of one embodiment of a file searching method using the computing device 1. In one embodiment, the method is performed by execution of computer-readable software program codes or instructions by the at least one processor 11 of the computing device 1. Depending on the embodiment, additional steps may be added, others removed, and the ordering of the steps may be changed.

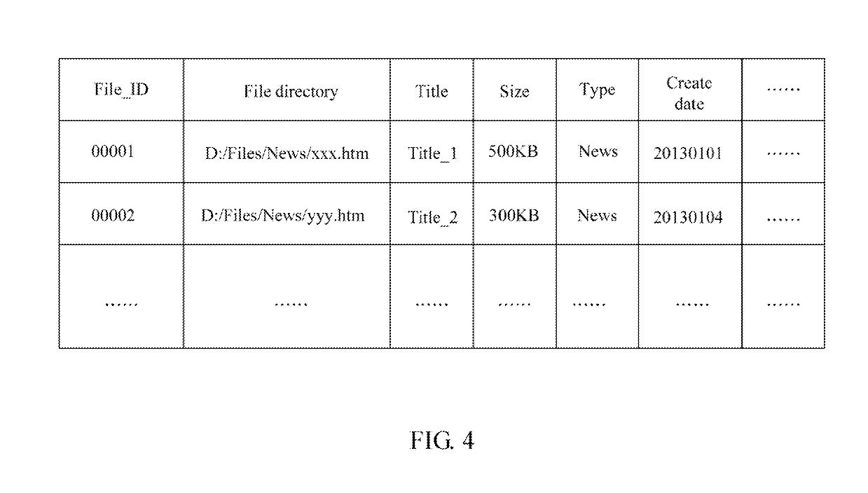

In step S01, the file analysis module 100 obtains an electronic file from the database when a user inputs a file name from the terminal device 2, and analyzes the electronic file to obtain a title and text content of the electronic file. In one embodiment, the text content of the electronic file may be in an English form or a Chinese form. In one example with respect to FIG. 4, when a file ID (File_{—}0001) is inputted from the terminal device 2, the file name “xxx.htm” is obtained from a file directory, for example, “D:/Files/News” stored in the database, and the title “Title_{—}1” and the text content “xxxxxxx” are analyzed from the electronic file.

In step S02, the file segmenting module 101 divides the text content into a plurality of text segments using a term identification rule. In one embodiment, the term identification rule may be a word identification rule, a statistical word identification rule or a hybrid word identification rule. In the embodiment, the file segmenting module 101 performs a segmenting operation on the text content using the hybrid word identification rule, and an arithmetical statement of the segmenting operation refers to the following exemplary code: expression 1-1 denoted as F[i]>1, expression 1-2 denoted as TF[i]>1, and expression 1-3 denoted as F[i]=TF[i]. Wherein F[i] represents a first number of a specify term presented in the text content, TF[i] represents a second number of a same term related to the specify term presented in the text content. The file segmenting module 101 compares the title of the electronic file with a plurality of related common terms in the common term library using the hybrid word identification rule to divide the text content into a plurality of text segments.

It should be noted that the text content of the electronic file may be in an English form or a Chinese form. If the text content of the electronic file is in English form, step S02 is omitted, the file segmenting module 101 only performs a simple segmenting operation on the text content of the file, such as deleting blank symbols, space symbols, and punctuation symbols from the text content of the file, and then step S03 is implemented. If the text content of the electronic file is in Chinese from, step S02 is implemented to perform the segmenting operation on the text content of the file, as described above.

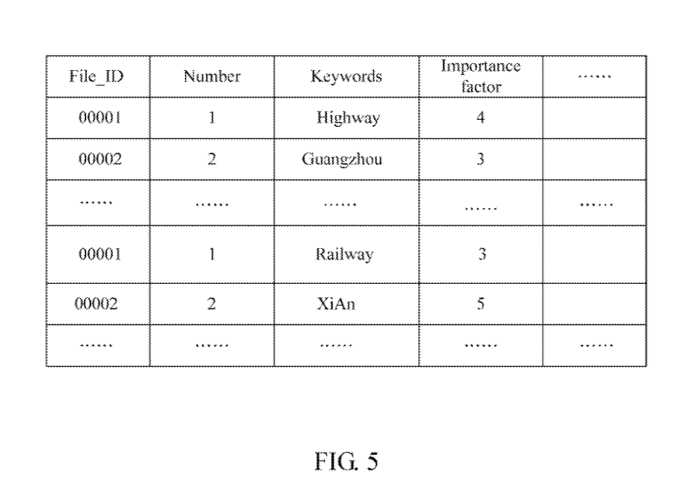

In step S03, the term extracting module 102 extracts keywords from each of the text segments using a term frequency-inverse document frequency (TF-IDF) rule or a term frequency (TF) rule. In one embodiment, the keywords are extracted from each of the text segments performing the following steps: (a) filtering a plurality of common terms from each of the text segments according to the common term library, for example, the terms “today,” “we,” “and,” and related terms which are recorded in the common term library are filtered from the text segment; (b) calculating a weight value of each term in each of the text segments; (c) ranking all the terms in a descending order according to the weight value of each term in the each of the text segments; and (d) determining m terms which are ranked from the first term to the m^{th} term as the keywords. In one embodiment, the weight value of each term is calculated according to the following equation: Wi=N*Wc+M*Wt, wherein Wi represents a weight value of a term, N represents a number of times of the term which is presented in the text content of the file, Wc represents a weight value of the text content of the file, M represents a number of times of the term which is presented in the title of the file, and Wt represents a weight value of the title of the file. In the embodiment, the weight value of the text content of the file may be defined as “1”, and the weight value of the title may be defined as “3”. Referring to FIG. 5, the keywords “highway” and “Guangzhou,” or “Railway” and “XiAn” are extracted from the text segments by performing the keyword extraction as described above.

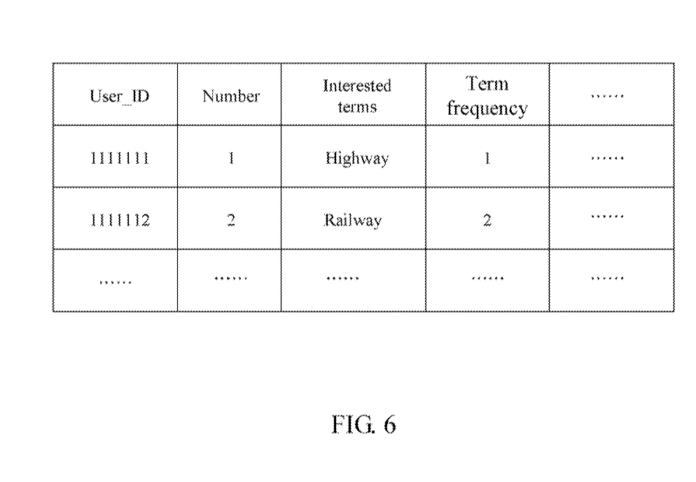

In step S04, the statistics analysis module 103 calculates an importance factor of each of the keywords, obtains a history record of the keywords for querying the file in a recent period (e.g., one day, one week or one month), and obtains one or more interested terms from the keywords according to the importance factor of each of the keywords and the history record of the keywords. In the embodiment, the importance factor of each keyword is defined as a relevance or importance of the keyword relevant to the interested terms, and is calculated according to the following equation: Fitness=100×log Feq/log(|K−N/2|+1), wherein Fitness represents an importance factor of a keyword, Feq represents a term frequency of the keyword, K represents a total number of electronic files which include the keyword, and N represents a total numbers of the electronic files which are queried by users of the terminal device 2. In the embodiment, the statistics analysis module 103 ranks all the keywords in a descending order according to the importance factors of the keywords and the history records of the keywords, and determines r keywords which are ranked from the first keyword to the r^{th} keyword as the interested terms. The interested terms represent terms of user's interest, that is, the files which includes information that the user most expects to view. Referring to FIG. 6, the interested terms may be “highway” or “railway,” which the user is interested in.

In step S05, the file searching module 104 obtains search results from the database by performing a search operation according to the interested terms, calculates a relevance degree between each file in the search results and the interested terms, ranks the files according to the calculated relevance degree, and sends the files with a ranking order to the terminal device 2. The search results may include a plurality of related files which are relevant to the interested terms. In one embodiment, the relevance degree is defined as a relationship between each file in the search results and the interested terms. The larger the value of the relevance degree, the more relevant the ranking content is to the file, that is, the file is, or is closer to, what the user most expects to query or view. In the embodiment, the file searching module 104 may rank the files in the search results in a descending order or in an ascending order according to the relevance degree between each file in the search results and the interested terms.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device connected to one or more terminal devices, the computing device comprising:
at least one processor; and
a storage device storing a computer-readable program comprising instructions that, which when executed by the at least one processor, causes the at least one processor to:
obtain a file from a database of the storage device when a user inputs a file name from one of the terminal devices, and analyze the file to obtain a title and text content of the file;
extract keywords from the text content using a term frequency-inverse document frequency (TF-IDF) rule;
calculate an importance factor of each of the keywords, obtain a history record of the keywords for querying the file in a recent period, and obtain one or more interested terms from the keywords according to the importance factor of each of the keywords;
obtain search results from the database by performing a search operation according to the interested terms, and calculate a relevance degree between each file in the search results and the interested terms; and
rank the files according to the calculated relevance degrees, and send the files with a ranking order to the terminal device.

2. The computing device according to claim 1, wherein the computer-readable program further causes the at least one processor to divide the text content into a plurality of text segments using a hybrid word identification rule.

3. The computing device according to claim 2, wherein the keywords are extracted from the text content performing steps of:
filtering a plurality of common terms from each of the text segments according to the common term library;
calculating a weight value of each term in the each of the text segments;
ranking all the terms in a descending order according to the weight value of each term in the each of the text segments; and
determining m terms which are ranked from the first term to the m^{th} term as the keywords.

4. The computing device according to claim 1, wherein the database comprises a keyword library that stores a plurality of keywords that are used frequently, and a common term library that stores a plurality of common terms which are unimportant or unrelated to the keywords.

5. The computing device according to claim 1, wherein the importance factor of each of the keywords is defined as an importance of the keyword relevant to the interested terms, and is calculated according to the following equation: Fitness=100×log Feq/log(|K−N/2|+1), wherein Fitness represents an importance factor of the keyword, Feq represents a term frequency of the keyword, K represents a total number of electronic files which include the keyword, and N represents a total numbers of the electronic files which are queried by users of the terminal device.

6. The computing device according to claim 1, wherein the files in the search results are ranked in a descending order or in an ascending order according to the relevance degree between each file in the search results and the interested terms.

7. A file searching method using a computing device, the computing device being connected to one or more terminal devices, the method comprising:
obtaining a file from a database of the storage device when a user inputs a file name from one of the terminal devices, and analyzing the file to obtain a title and text content of the file;
extracting keywords from the text content using a term frequency-inverse document frequency (TF-IDF) rule;
calculating an importance factor of each of the keywords, obtaining a history record of the keywords for querying the file in a recent period, and obtaining one or more interested terms from the keywords according to the importance factor of each of the keywords;
obtaining search results from the database by performing a search operation according to the interested terms, and calculating a relevance degree between each file in the search results and the interested terms; and
ranking the files according to the calculated relevance degrees, and sending the files with a ranking order to the terminal device.

8. The method according to claim 7, further comprising:
dividing the text content into a plurality of text segments using a hybrid word identification rule.

9. The method according to claim 8, wherein the keywords are extracted from the text content performing steps of:
filtering a plurality of common terms from each of the text segments according to the common term library;
calculating a weight value of each term in the each of the text segments;
ranking all the terms in a descending order according to the weight value of each term in the each of the text segments; and
determining m terms which are ranked from the first term to the m^{th} term as the keywords.

10. The method according to claim 7, wherein the database comprises a keyword library that stores a plurality of keywords that are used frequently, and a common term library that stores a plurality of common terms which are unimportant or unrelated to the keywords.

11. The method according to claim 7, wherein the importance factor of each of the keywords is defined as an importance of the keyword relevant to the interested terms, and is calculated according to the following equation: Fitness=100×log Feq/log(|K−N/2|+1), wherein Fitness represents an importance factor of the keyword, Feq represents a term frequency of the keyword, K represents a total number of electronic files which include the keyword, and N represents a total numbers of the electronic files which are queried by users of the terminal device.

12. The method according to claim 7, wherein the files in the search results are ranked in a descending order or in an ascending order according to the relevance degree between each file in the search results and the interested terms.

13. A non-transitory storage medium having stored thereon instructions that, when executed by at least one processor of a computing device, causes the processor to perform a file searching method, the computing device being connected to one or more terminal devices, the method comprising:
obtaining a file from a database of the storage device when a user inputs a file name from one of the terminal devices, and analyzing the file to obtain a title and text content of the file;
extracting keywords from the text content using a term frequency-inverse document frequency (TF-IDF) rule;
calculating an importance factor of each of the keywords, obtaining a history record of the keywords for querying the file in a recent period, and obtaining one or more interested terms from the keywords according to the importance factor of each of the keywords;
obtaining search results from the database by performing a search operation according to the interested terms, and calculating a relevance degree between each file in the search results and the interested terms; and
ranking the files according to the calculated relevance degrees, and sending the files with a ranking order to the terminal device.

14. The storage medium according to claim 13, wherein the method further comprises:
dividing the text content into a plurality of text segments using a hybrid word identification rule.

15. The storage medium according to claim 14, wherein the keywords are extracted from the text content performing steps of:
filtering a plurality of common terms from each of the text segments according to the common term library;
calculating a weight value of each term in the each of the text segments;
ranking all the terms in a descending order according to the weight value of each term in the each of the text segments; and
determining m terms which are ranked from the first term to the m^{th} term as the keywords.

16. The storage medium according to claim 13, wherein the database comprises a keyword library that stores a plurality of keywords that are used frequently, and a common term library that stores a plurality of common terms which are unimportant or unrelated to the keywords.

17. The storage medium according to claim 13, wherein the importance factor of each of the keywords is defined as an importance of the keyword relevant to the interested terms, and is calculated according to the following equation: Fitness=100×log Feq/log(|K−N/2|+1), wherein Fitness represents an importance factor of the keyword, Feq represents a term frequency of the keyword, K represents a total number of electronic files which include the keyword, and N represents a total numbers of the electronic files which are queried by users of the terminal device.

18. The storage medium according to claim 13, wherein the files in the search results are ranked in a descending order or in an ascending order according to the relevance degree between each file in the search results and the interested terms.
